(19) United States
(12) Patent Application Publication
(10) Pub. No.: US 2013/0262253 A1
(43) Pub. Date: Oct. 3, 2013

(54) Push-Pull Shopping System and Method Thereof

(71) Applicant: DADNY INC., Taipei City (TW)

(72) Inventor: Daniel Shih, Taipei City (TW)

(73) Assignee: dadny Inc., Taipei City (TW)

(21) Appl. No.: 13/666,070

(22) Filed: Nov. 1, 2012

(30) Foreign Application Priority Data
Apr. 3, 2012 (TW) 101111945

(51) Int. Cl. G06Q 30/06

(52) U.S. Cl. 705/26.1

(57) ABSTRACT

A push-pull shopping system and a method thereof. The system comprises a first electronic device, a plurality of second electronic devices and a system server. The system provides an on-line shopping platform. The first and the second electronic devices are connected to the on-line shopping platform through the system server. A buyer transmits a request-to-buy message related to a specific object via the first electronic device to the system server and then the system server displays the request-to-buy message to the on-line shopping platform. Purchasers acting on behalf of the buyer transmit condition messages in response to the request-to-buy message to the on-line shopping platform through the second electronic devices for the buyer to choose therefrom.

### CROSS-REFERENCE TO RELATED APPLICATION

This application claims the benefit of Taiwan Patent Application No. 101111945, filed on Apr. 3, 2012, in the Taiwan Intellectual Property Office, the disclosure of which is incorporated herein in its entirety by reference.

### BACKGROUND OF THE INVENTION

1. Field of the Invention

The present invention relates to an online shopping system, and more particularly to a push-pull shopping system and a method thereof that allow buyers to specific a desired product and provide a plurality of purchasers acting on behalf of the buyer for the buyers to choose therefrom, and further help buyers to find the purchasers acting on behalf of the buyer in the neighborhood of a specified buying location.

2. Description of Related Art

In recent years, the development of Internet blooms and thus e-Commerce has become a mainstream of technological applications. As our life becomes increasingly busier, and our work pressure becomes increasingly higher, we generally have no time for shopping, so that online shopping has become a popular shopping mode. With the advantages of providing a variety of products, low price, and convenience, online shopping is extensively used by the general public.

However, conventional online shopping systems still have many drawbacks. For example, after a buyer purchases a merchandise item, the buyer has to wait for a certain time before the merchandise item is delivered. Although an online shopping system provides a variety of products, yet there are often specific products not available. Even when the buyer has browsed many online shopping websites, the desired product still cannot be found. When the buyer needs to buy a specific product at a specific location, all the buyer can do is to follow a fixed procedure, a fixed price and a fixed product delivery time. In addition, although the conventional online shopping system provides a variety of products for buyers to select, yet the buyers still need to switch the web pages constantly to find their desired products. Obviously, this is very inefficient. In addition, although the conventional online shopping system provides quick services to the buyers, the buyer's enjoyment of shopping is reduced.

Therefore, it is a main subject for the present invention to provide an online shopping system with the function of a general shopping website and the capability of providing product information for buyers to purchase a product quickly without the need of switching webpages continuously, improving the enjoyment of shopping, and providing a plurality of purchasers acting on behalf of the buyer for the buyer to choose therefrom.

### SUMMARY OF THE INVENTION

In view of the aforementioned problems of the prior art, it is a primary objective of the present invention to provide a push-pull shopping system and a method thereof to overcome the problems of the conventional online shopping system.

To achieve the aforementioned objective, the present invention provides a push-pull shopping system comprising: a first electronic device; a plurality of second electronic devices; and a system server arranged for executing an on-line shopping platform, and connecting the first electronic device and the plurality of second electronic devices; wherein a buyer issues a request-to-buy message related to a specific object through the first electronic device, and the system server displays the request-to-buy message on the on-line shopping platform, and each purchaser acting on behalf of the buyer transmits a condition message from the second electronic device to the on-line shopping platform according to the request-to-buy message for the buyer to choose therefrom.

Preferably, the push-pull shopping system generates the condition message according to the price and time required for the shopping decided by each of the purchasers acting on behalf of the buyer.

Preferably, the buyer makes a payment through a pre-authorized online payment mechanism to authorize a specified purchaser acting on behalf of the buyer in advance to buy the specific object.

Preferably, the buyer makes a payment through a pre-authorized online payment mechanism to authorize a specified purchaser acting on behalf of the buyer in advance to buy the specific object.

Preferably, the online payment mechanism is an online transaction payment platform or a credit card.

Preferably, the specified purchaser acting on behalf of the buyer inputs a delivery order number of the specific object through the on-line shopping platform and notices the buyer by a message before the buyer can receive the payment through the online payment mechanism.

To achieve the aforementioned objective, the present invention provides a push-pull shopping method comprising the steps of: executing an on-line shopping platform by a system server to let a first electronic device and a plurality of second electronic devices to connect the on-line shopping platform; using the first electronic device to transmit a buyer's request-to-buy message related to a specific object to the on-line shopping platform; and using each of the second electronic devices to transmit a condition message replied by each of the purchaser acting on behalf of the buyer to the on-line shopping platform, and providing the condition message for the buyer to choose therefrom.

Preferably, if the request-to-buy message includes a specific buying location specified by the buyer, the system server transmits the request-to-buy message to each of the second electronic devices near the specified buying location, and provides the request-to-buy message to be replied by each purchaser acting on behalf of the buyer.

Preferably, the push-pull shopping system generates the condition message according to the price and time for purchasing the specific product decided by each of the purchasers acting on behalf of the buyer.

Preferably, the system server transmits the request-to-buy message according to position information provided by each of the second electronic devices.

Preferably, the system server transmits the request-to-buy message to each of the second electronic devices within a predetermined range of a distance from the specified buying location.

Preferably, the request-to-buy message includes a desired product, a location for buying the desired product, and a description of the desired product.

Preferably, the method further comprises the step of: receiving a payment made by the buyer through a pre-authorized online payment mechanism to authorize a specified purchaser acting on behalf of the buyer in advance to buy the specific object.

Preferably, the online payment mechanism is an online transaction payment platform or a credit card.

Preferably, the method further comprises the step of: receiving a delivery order number of the specific object inputted by the specified purchasers acting on behalf of the buyer, noticing the buyer by a message, and making payment to the specified purchaser acting on behalf of the buyer through the online payment mechanism by the on-line shopping platform.

In summation, the push-pull shopping system and method in accordance with the present invention have one or more of the following advantages:

(1) The push-pull shopping system and method of the present invention can provide the product information to a buyer quickly without requiring the buyer to switch the webpages continuously, and provide the desired product quickly, so as to achieve a high efficiency of the application.

(2) The push-pull shopping system and method of the present invention can provide any user specified product, so as to provide a more convenient way for shopping.

(3) The push-pull shopping system and method of the present invention lets the purchaser acting on behalf of the buyer decide the price and delivery time of the product to be provided to the buyer, and the buyer can select the suitable price and delivery time of the product according to personal preference, so as to provide better flexibility to the buyer.

(4) The push-pull shopping system and method of the present invention allow buyers and purchasers acting on behalf of the buyer to interact with each other through the on-line shopping platform to attract more members to join the on-line shopping platform, and thus the invention has high commercial values.

(5) The push-pull shopping system and method of the present invention provides a novel shopping method to buyers and improves the buyers' fun of shopping and their willingness to buy.

(6) The push-pull shopping system and method of the present invention can transmit request-to-buy messages actively to notice purchasers acting on behalf of the buyer at specific locations, so as to provide more purchasers acting on behalf of the buyer for the buyer to choose therefrom.

### BRIEF DESCRIPTION OF THE DRAWINGS

FIG. 1 is a block diagram of a push-pull shopping system of the present invention;

FIG. 2 is a flow chart of a push-pull shopping system in accordance with a first preferred embodiment of the present invention;

FIGS. 3 to 6 are schematic views of a push-pull shopping system in accordance with the first preferred embodiment of the present invention;

FIG. 7 is a block diagram of a push-pull shopping system in accordance with a second preferred embodiment of the present invention;

FIG. 8 is a flow chart of a push-pull shopping system in accordance with the second preferred embodiment of the present invention;

FIGS. 9 to 11 are schematic views of a push-pull shopping system in accordance with the second preferred embodiment of the present invention; and

FIG. 12 is a flow chart of a push-pull shopping method of the present invention.

### DETAILED DESCRIPTION OF THE PREFERRED EMBODIMENTS

The technical characteristics of the present invention will become apparent with the detailed description of preferred embodiments and the illustration of related drawings as follows. It is noteworthy that same numerals are used to represent same respective elements in the following embodiments.

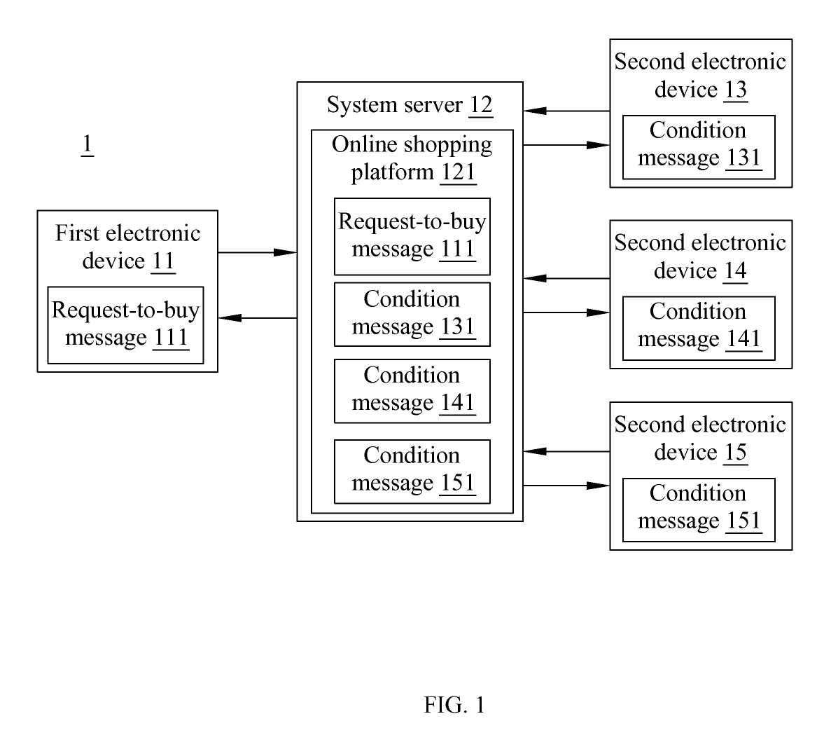

With reference to FIG. 1 for a block diagram of a push-pull shopping system of the present invention, the push-pull shopping system 1 comprises a first electronic device 11, a system server 12 and a plurality of second electronic devices 13, 14 and 15. It is noteworthy that the quantity of second electronic devices is not limited to three only, but any other appropriate quantity can be used in the invention, and FIG. 1 shows only three of them for the purpose of illustrating the invention only.

The system server 12 executes an on-line shopping platform 121, and the first electronic device 11 and the plurality of second electronic devices 13, 14 and 15 can connect to the on-line shopping platform 121 via the Internet. If a buyer wants to buy a specific object, the buyer can use the first electronic device 11 to issue a request-to-buy message 111, wherein the request-to-buy message 111 includes a buyer account number, and detailed description of the desired product including the name, the expected product delivery time of the desired product. The system server 12 receives the request-to-buy message 111 and announces the request-to-buy message on the on-line shopping platform 121.

The plurality of purchasers acting on behalf of the buyer can be connected to the on-line shopping platform 121 through the plurality of second electronic devices 13, 14 and 15 to view the request-to-buy message 111. Each purchaser acting on behalf of the buyer can reply a condition message 131, 141 and 151 according to the detailed description of the desired product such as the name, the expected product delivery time of the desired product described in the request-to-buy message 111 and according to the need of purchaser acting on behalf of the buyer, wherein the condition message 131, 141 and 151 includes the price and time for purchasing the specific object, and the account number of the purchaser acting on behalf of the buyer. In other words, the push-pull shopping system of the present invention allows the purchaser acting on behalf of the buyer to decide the offered price and the product delivery time to the buyer. Similarly, each purchaser acting on behalf of the buyer can view the request-to-buy messages 111 issued by different buyers from the on-line shopping platform 121 and provide the request-to-buy message 111 for the buyer to choose therefrom.

The buyer receives a condition message 131, 141 and 151 transmitted from different purchasers acting on behalf of the buyer via the on-line shopping platform 121 and evaluates the conditions provided by each purchaser acting on behalf of the buyer according to personal needs. The buyer can specify one of the condition messages 131, 141 and 151 that matches the personal needs most, and a message is used to notice a purchaser acting on behalf of the buyer corresponding to the specified condition message. The specified purchaser acting on behalf of the buyer specified by the buyer can start helping the buyer to buy the specified product according to the condition message issued by the purchaser acting on behalf of the buyer.

It is noteworthy that although the conventional online shopping system can provide a variety of products, the buyer still needs to switch the webpage continuously to find the desired product. In addition, a certain specified product such as a limited edition of famous-branded purses and clothes will not be displayed on a virtual shelf of a general shopping website. The push-pull shopping system of the present invention not only provides general online shopping services, but also allows the buyer to specify a desired product, and buy the desired product through the specified purchaser acting on behalf of the buyer. Therefore, the push-pull shopping system of the present invention surely can improve the low efficiency of the conventional online shopping system effectively.

On the other hand, the push-pull shopping system of the present invention allows the buyer to select the most suitable shopping conditions of the buyer, and thus provides the buyer more choices and better flexibility.

More importantly, the push-pull shopping system of the present invention allows buyers and purchasers acting on behalf of the buyer to interact with each other on the on-line shopping platform. In addition to consumers who want to by a desired product, this system also attracts purchasers acting on behalf of the buyer who buy for others in order to earn some money. As a result, the push-pull shopping system of the present invention attracts more members to join the on-line shopping platform, and thus the invention has high commercial values.

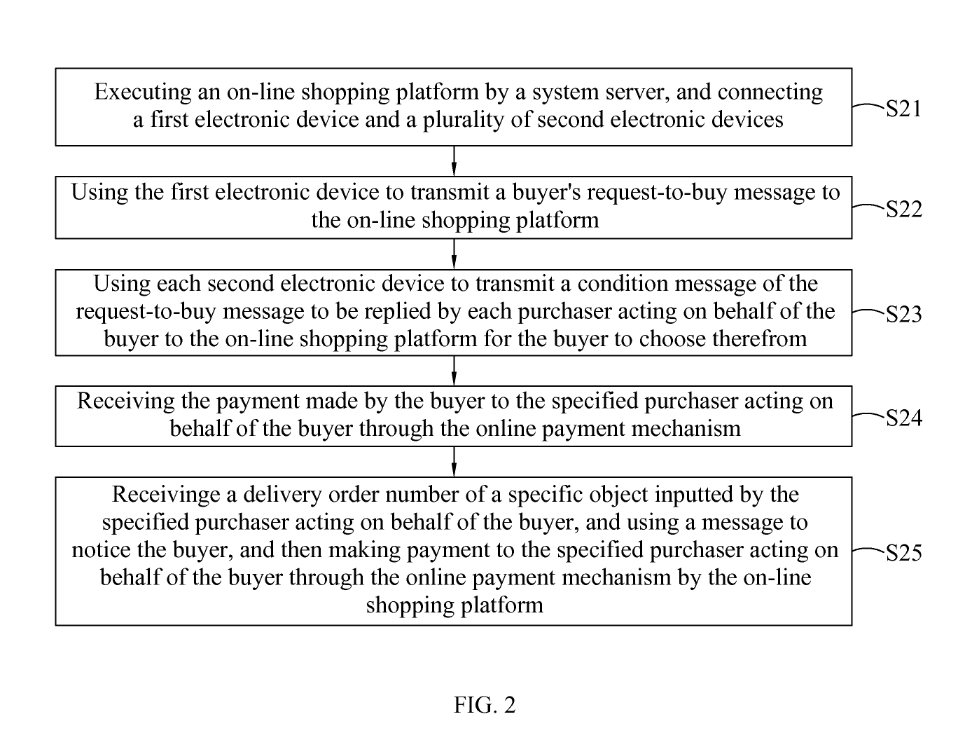

With reference to FIG. 2 for a flow chart of a push-pull shopping system in accordance with the first preferred embodiment of the present invention, the buyer specifies one of the most suitable condition messages specified in a plurality of condition messages, and uses a message to notice the purchaser acting on behalf of the buyer corresponding to the condition message, and makes payment through the pre-authorized online payment mechanism. In the meantime, the message is used to notice the purchaser acting on behalf of the buyer. The online payment mechanism can be an online transaction payment platform such as PAYPAL, or the payment can be made online by a credit card. Therefore, after the purchaser acting on behalf of the buyer receives message authorized by the buyer in advance, the purchaser acting on behalf of the buyer can start helping the buyer to buy the desired product according to the condition message provided by himself/herself.

After the purchaser acting on behalf of the buyer buys the specified product according to the condition message, the purchaser acting on behalf of the buyer can input a delivery order number of the product through the on-line shopping platform, and use a message to notice the buyer about the delivery order number and other information related to the product and let the buyer confirm the order. After the on-line shopping platform receives a confirmation message from the buyer, the on-line shopping platform makes payment pre-authorized by the buyer to the purchaser acting on behalf of the buyer through the online payment mechanism.

It is noteworthy that the push-pull shopping system of the present invention provides a novel shopping method to buyers and improves the buyers' fun of shopping and the interaction between the buyers and the purchasers acting on behalf of the buyer. Compared with the conventional online shopping system, the push-pull shopping system of the present invention can improve the buyers' fun of shopping and the buyers' willingness to buy.

In FIG. 2, the operation of the push-pull shopping system of this preferred embodiment comprises the following steps:

S21: Executing an on-line shopping platform by a system server, and connect a first electronic device and a plurality of second electronic devices.

S22: Using the first electronic device to transmit a buyer's request-to-buy message to the on-line shopping platform.

S23: Using each second electronic device to transmit a condition message that each purchaser acting on behalf of the buyer reply to the request-to-buy message to the on-line shopping platform for the buyer to choose therefrom.

S24: Receiving the payment that the buyer pays the specified purchaser acting on behalf of the buyer through the online payment mechanism.

S25: Receiving a delivery order number of a specific object inputted by the specified purchaser acting on behalf of the buyer, and using a message to notice the buyer, and then making payment to the specified purchaser acting on behalf of the buyer through the online payment mechanism by the on-line shopping platform.

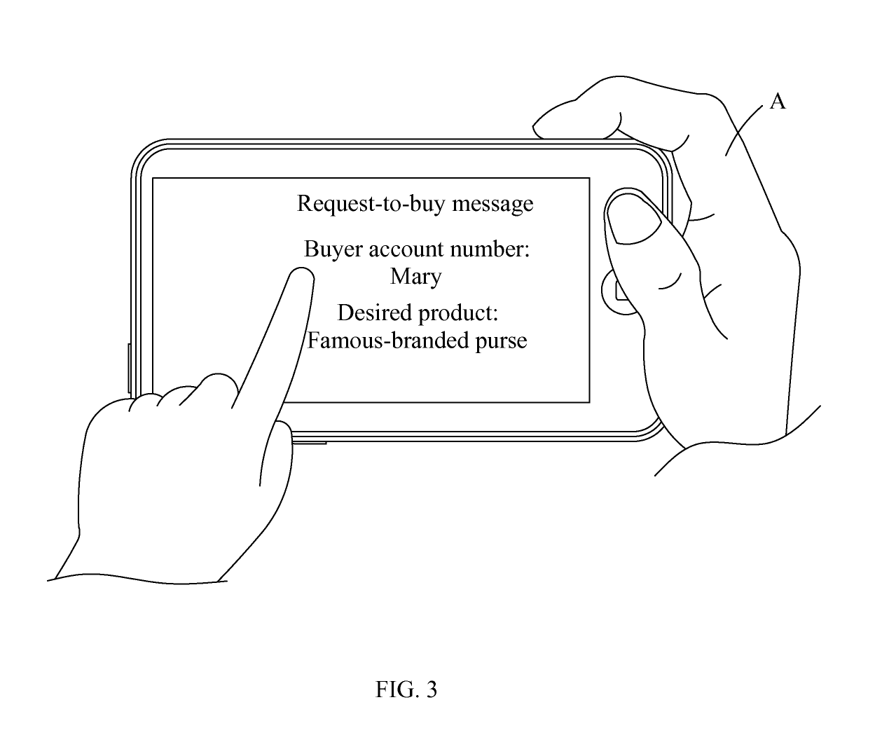

With reference to FIGS. 3 to 6 for schematic views of a push-pull shopping system in accordance with the first preferred embodiment of the present invention, if a buyer A wants to buy a special edition of “famous-branded purse” as shown in FIG. 3, the buyer A can connect to the on-line shopping platform through a mobile phone and edit the request-to-buy message of the famous-branded purse. The request-to-buy message includes a user account number, the name of a desired product, the expected product delivery time (not shown in the figure) and the detailed description (not shown in the figure) of the desired product.

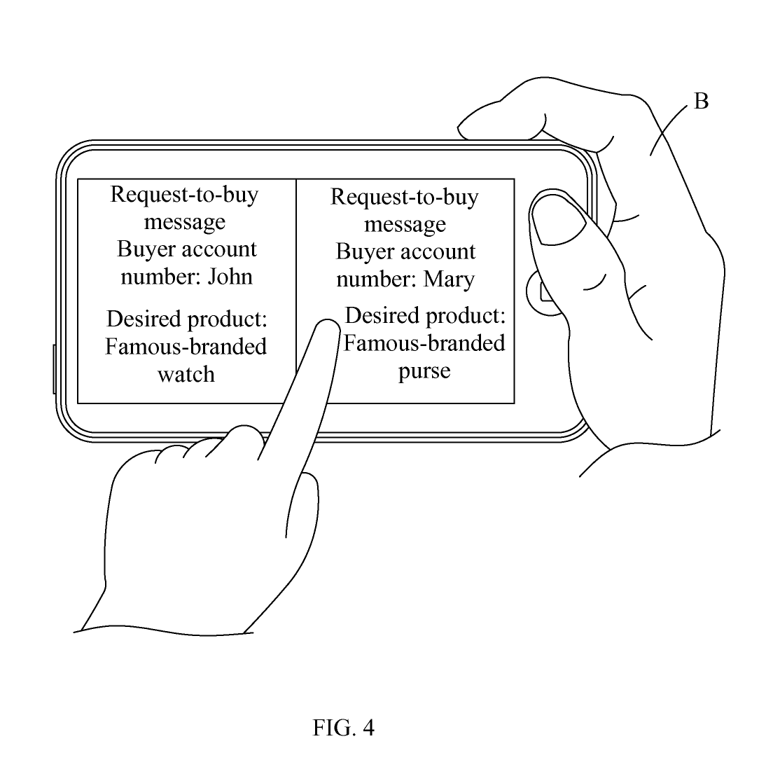

In FIG. 4, the on-line shopping platform announces request-to-buy messages of a plurality of buyers on a network, and the purchaser acting on behalf of the buyer B can use a mobile phone to connect to the on-line shopping platform, and select a request-to-buy message matched with the conditions of the purchaser acting on behalf of the buyer B most. In this preferred embodiment, the purchaser acting on behalf of the buyer B selects the request-to-buy message issued by the buyer A and replies a condition message to the buyer A according to the request-to-buy message.

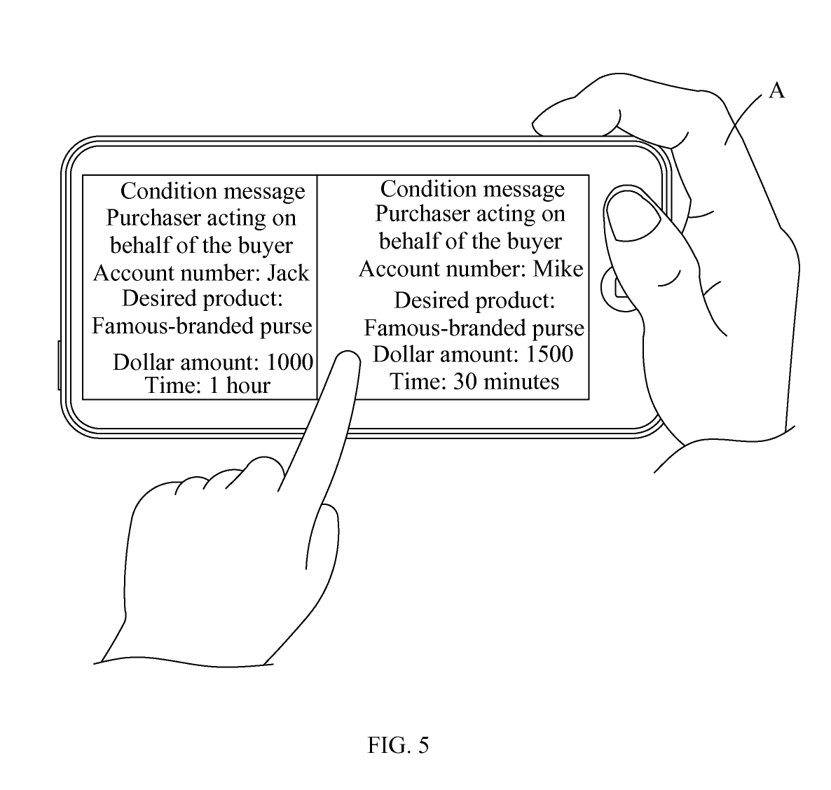

In FIG. 5, the buyer A can read the condition message replied from each purchaser acting on behalf of the buyer through the on-line shopping platform, and select the most suitable condition message according to the price and time required for the shopping described in the condition messages. In this preferred embodiment, the buyer A selects the condition message provided by the purchaser acting on behalf of the buyer B, uses the online payment mechanism to make the requested payment to the purchaser acting on behalf of the buyer B, notices the purchaser acting on behalf of the buyer B by a message, and authorizes the purchaser acting on behalf of the buyer B in advance to buy the desired product.

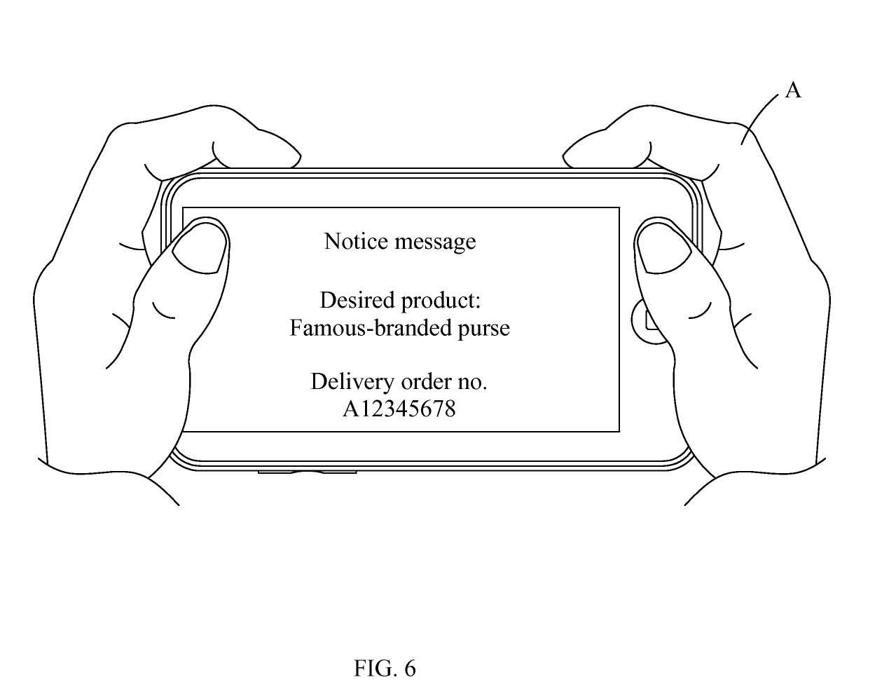

In FIG. 6, after the purchaser acting on behalf of the buyer B buys the specified famous-branded purse specified by the purchaser acting on behalf of the buyer A, the delivery order number of the famous-branded purse can be inputted from the on-line shopping platform, and a message is used to notice the buyer about the delivery order number and other related information (not shown in the figure) of the product, and provide the information for the confirmation of the buyer. After the on-line shopping platform receives a confirmation message from the buyer, the online payment mechanism makes the payment pre-authorized by the buyer to the purchaser acting on behalf of the buyer.

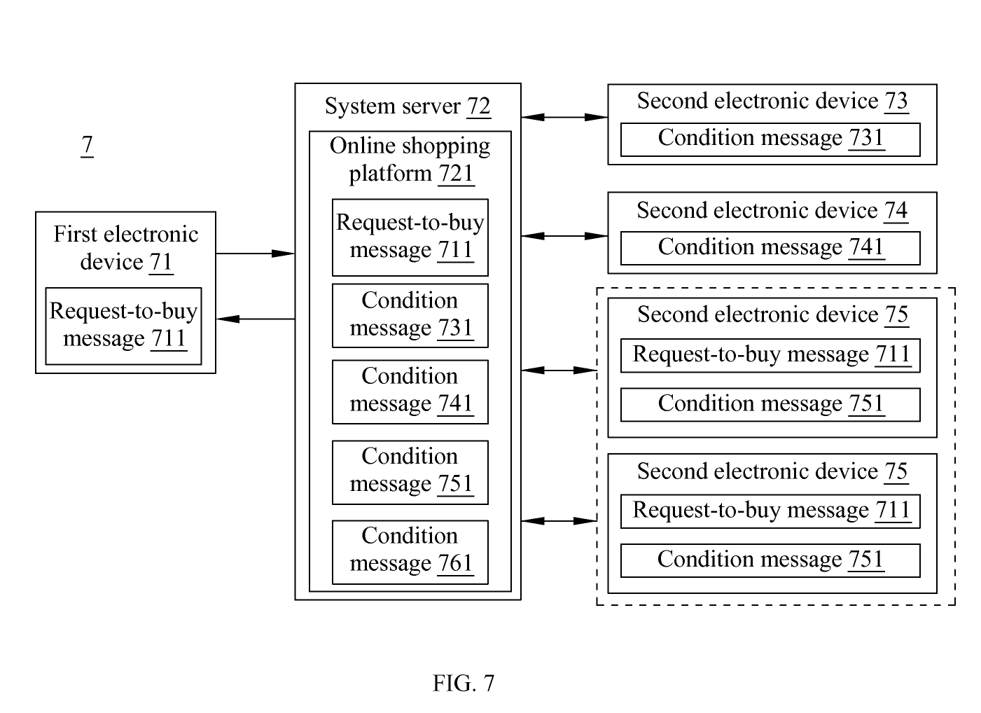

With reference to FIG. 7 for a block diagram of a push-pull shopping system in accordance with a second preferred embodiment of the present invention, the push-pull shopping system 7 comprises a first electronic device 71, a system server 72 and a plurality of second electronic devices 73, 74, 75 and 76. It is noteworthy that the quantity of second electronic devices is not limited to four only, but any other appropriate quantity can be used in the invention, and FIG. 1 shows only four of them for the purpose of illustrating the invention only.

The system server 72 executes an on-line shopping platform 721, and the first electronic device 71 and the plurality of second electronic devices 73, 74, 75 and 76 can connect to the system server 72 via the Internet to enter into the on-line shopping platform 721.

Wherein, if a buyer wants to buy a specific object at a specified buying location, the buyer can issue a request-to-buy message 711 from the first electronic device 71 to the system server 72. The system server 72 displays the request-to-buy message 711 on the on-line shopping platform 721 and provides the request-to-buy message 711 to be replied by each purchaser acting on behalf of the buyer that is connected to the on-line shopping platform 721.

The request-to-buy message 711 includes the description of the desired product and the location for buying the desired product. In addition, the system server 72 actively transmits the request-to-buy message 711 to the second electronic devices 75, 76 near a specific location specified in the request-to-buy message 711 by the user. Therefore, any purchaser acting on behalf of the buyer at the specified buying location specified by the buyer can receive the request-to-buy message 711, and any purchaser acting on behalf of the buyer who wants to buy the desired product for the buyer can reply to the request-to-buy message 711, so that the buyer can receive the reply quickly. In the meantime, other purchasers acting on behalf of the buyer can log on the on-line shopping platform 721 through the second electronic device 73, 74 to reply the request-to-buy message 711.

Each purchaser acting on behalf of the buyer can decide the price of the buyer's desired product and the product delivery time according to the request-to-buy message 711, and a condition message 731, 741, 751 and 761 can be replied to the buyer through the second electronic device 73, 74, 75 and 76 for the buyer to choose therefrom.

It is noteworthy that the conventional online shopping system only passively waits for the buyer to log on the Internet and browse the website, and simply displays the product on a virtual shelf of a hopping website. However, if the buyer wants to buy a product at a specified buying location, the conventional online shopping system can just follow a fixed procedure to provide a fixed service. On the other hand, the push-pull shopping system of the present invention not only provides a general online shopping service, but also searches for the purchaser acting on behalf of the buyer near the desired buying location specified by the buyer and actively transmits the request-to-buy message to request each purchaser acting on behalf of the buyer to participate into the shopping-for-you activity, so as to provide the related information to the buyer and the plurality of purchasers acting on behalf of the buyer.

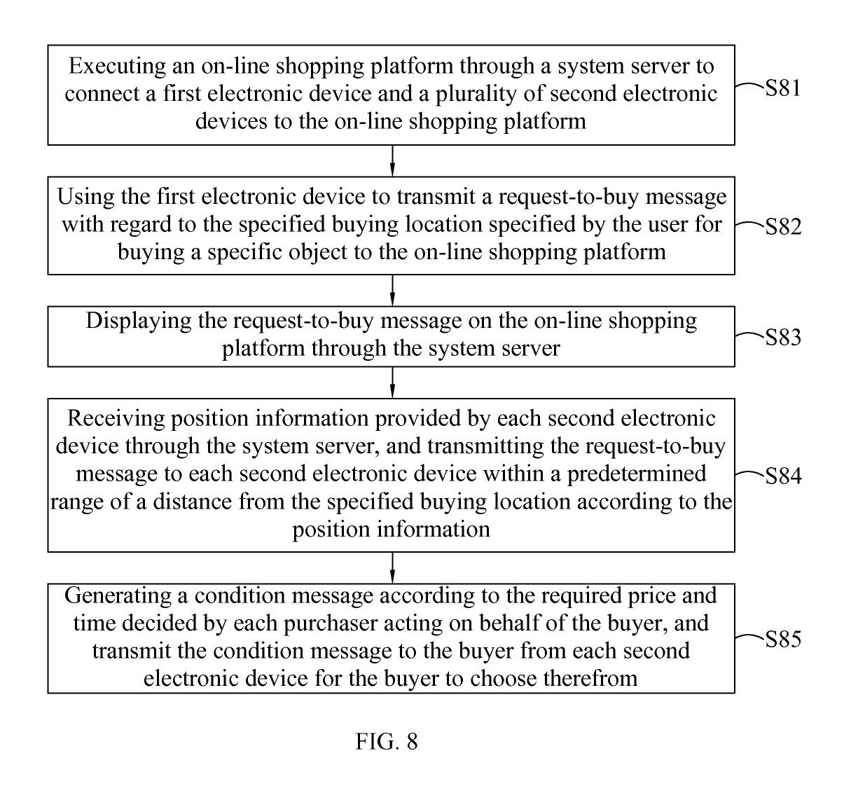

With reference to FIG. 8 for a flow chart of a push-pull shopping system in accordance with the second preferred embodiment the present invention, the operation of the system comprises the following steps.

S81: Executing an on-line shopping platform through a system server to connect a first electronic device and a plurality of second electronic devices to the on-line shopping platform.

S82: Using the first electronic device to transmit a request-to-buy message with regard to the specified buying location specified by the user for buying a specific object to the on-line shopping platform.

S83: Displaying the request-to-buy message on the on-line shopping platform through the system server.

S84: Retrieving position information provided by each second electronic device through the system server, and transmitting the request-to-buy message to each second electronic device within a predetermined range of a distance from the specified buying location according to the position information.

S85: Generating a condition message according to the required price and time decided by each purchaser acting on behalf of the buyer, and transmitting the condition message to the buyer via the second electronic device for the buyer to choose therefrom.

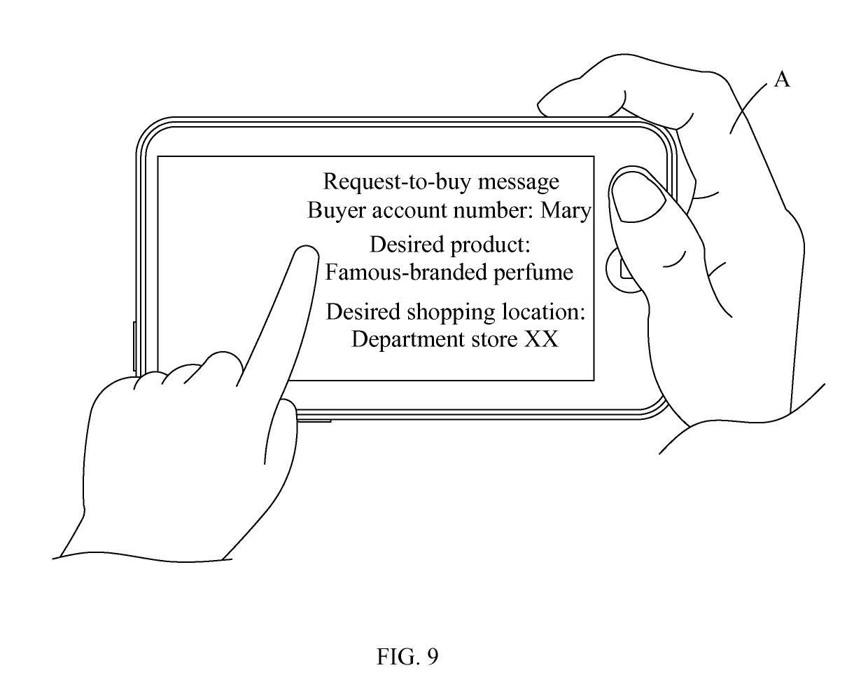

With reference to FIGS. 9 to 11 for schematic views of a push-pull shopping system in accordance with the second preferred embodiment of the present invention, if a member A (or buyer) wants to buy a famous-branded perfume from a department store XX as shown in FIG. 9, uses a mobile phone to connect the system server to enter into the on-line shopping platform, and issues a request-to-buy message, the system server will display the request-to-buy message on the on-line shopping platform and provide the request-to-buy message for the view by each member.

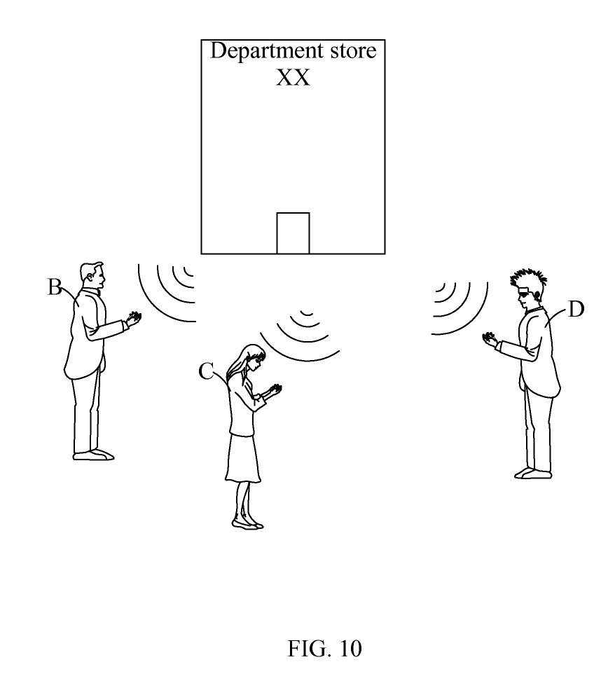

In FIG. 10, the system server not only announces the request-to-buy message on the on-line shopping platform, but also uses position information provided by a mobile phone of each member to search for a member near the department store XX. If there is a member situated within a predetermined range from the department store XX, then the system server will transmit the request-to-buy message of the purchaser acting on behalf of the buyer A to the member near the department store XX. In this preferred embodiment, the system server finds that there are three members B, C and D (or purchasers acting on behalf of the buyer) situated at positions near the department store XX, so that the request-to-buy message is transmitted to the three members to actively request the three members to participate into this buying-for-you activity.

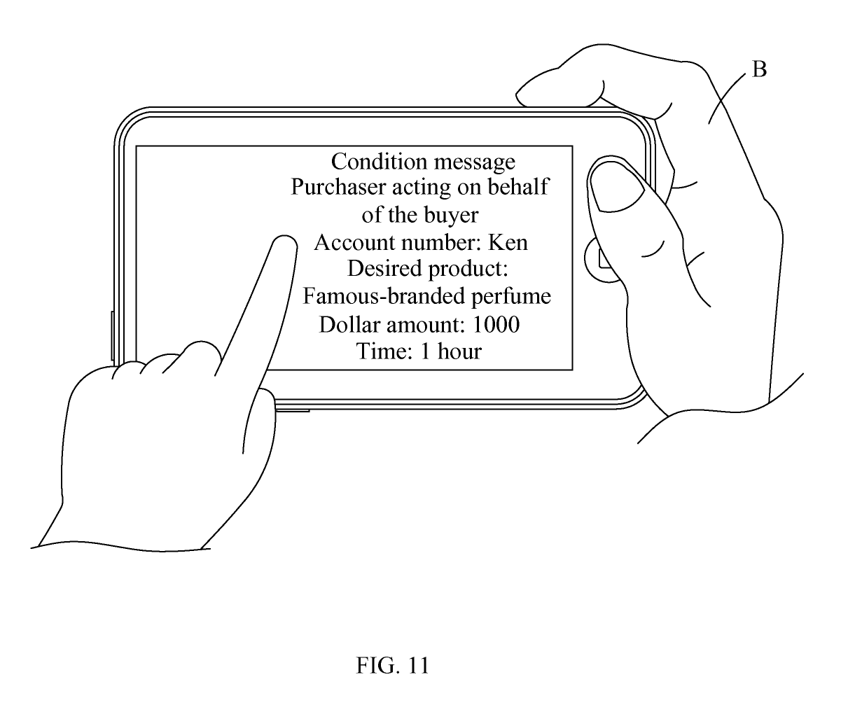

In FIG. 11, the member B decides the price and time required for the shopping according to the request-to-buy message, replies a condition message to the member A and provides the condition message for the member A to choose therefrom.

Even though the concept of the push-pull shopping method of the present invention has been described in the section of the push-pull shopping system, the description of the following flow chart is provided for illustrating the invention more clearly.

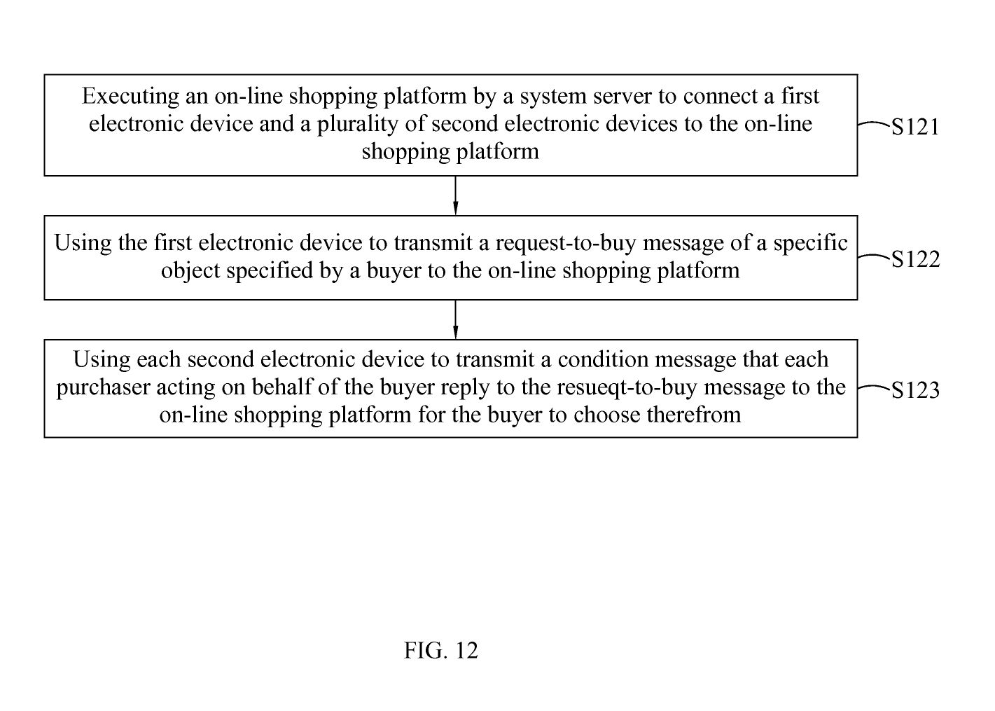

With reference to FIG. 12 for a flow chart of a push-pull shopping method of the present invention, the method comprises the following steps.

S121: Executing an on-line shopping platform by a system server to connect a first electronic device and a plurality of second electronic devices to the on-line shopping platform.

S122: Using the first electronic device to transmit a request-to-buy message of a specific object specified by a buyer to the on-line shopping platform.

S123: Using each second electronic device to transmit a condition message replied to the request-to-buy message by each purchaser acting on behalf of the buyer to the on-line shopping platform for the buyer to choose therefrom.

In summation, the push-pull shopping system and method of the present invention can provide the desired product to a buyer quickly without requiring the buyer to switch the webpages continuously, so as to achieve a high efficiency of the application. In addition, the push-pull shopping system and method of the present invention not only provide any product specified by the user, but also allows the buyer to select the most appropriate price and product delivery time according the buyer's needs, so as to provide better convenience and flexibility to buyers. The push-pull shopping system and method of the present invention allows buyers and purchasers acting on behalf of the buyer to interact with each other through the on-line shopping platform, not only improving the fun of shopping, but also attracting more members to join the on-line shopping platform, and thus the invention has high commercial values. The push-pull shopping system and method of the present invention can actively send out the request-to-buy message to notice a purchaser acting on behalf of the buyer at a specified location, so as to provide more purchasers acting on behalf of the buyer for the buyer to choose therefrom.

In summation of the description above, the present invention breaks through the prior art, and achieves the expected improvement, and complies with patent application requirements and is thus duly filed for patent application.

What is claimed is:

1. A push-pull shopping system, comprising:
a first electronic device;
a plurality of second electronic devices; and
a system server, arranged for executing an on-line shopping platform, and connecting to the first electronic device and the plurality of second electronic devices;
wherein a buyer issues a request-to-buy message related to a specific object through the first electronic device, and the system server receives the request-to-buy message and displays the request-to-buy message on the on-line shopping platform, and each purchaser acting on behalf of the buyer transmits a condition message from the second electronic device to the on-line shopping platform according to the request-to-buy message for the buyer to choose therefrom.

2. The push-pull shopping system of claim 1, wherein if the request-to-buy message includes a specific buying location specified by the buyer, the system server transmits the request-to-buy message to each of the second electronic devices near the specified buying location for the purchasers acting on behalf of the buyer to reply to.

3. The push-pull shopping system of claim 1, wherein the condition message comprises a price and a time for purchasing the specific object, and the price and the time for purchasing the specific object are determined by each of the purchasers acting on behalf of the buyer.

4. The push-pull shopping system of claim 2, wherein the condition message comprises a price and a time for purchasing the specific object, and the price and the time for purchasing the specific object are determined by each of the purchasers acting on behalf of the buyer.

5. The push-pull shopping system of claim 2, wherein the system server transmits the request-to-buy message to each of the second electronic devices according to position information provided by each of the second electronic devices.

6. The push-pull shopping system of claim 5, wherein the system server transmits the request-to-buy message to each of the second electronic devices within a predetermined range of distance from the specified buying location.

7. The push-pull shopping system of claim 1, wherein the request-to-buy message includes a desired product, a location for buying the desired product, and a description of the desired product.

8. The push-pull shopping system of claim 1, wherein the buyer makes a payment through a pre-authorized online payment mechanism to authorize a specified purchaser acting on behalf of the buyer in advance to buy the specific object.

9. The push-pull shopping system of claim 8, wherein the online payment mechanism is an online transaction payment platform or a credit card.

10. The push-pull shopping system of claim 8, wherein the specified purchaser acting on behalf of the buyer inputs a delivery order number of the specific object through the on-line shopping platform and notify the buyer by a message before receiving the payment through the online payment mechanism.

11. A push-pull shopping method, comprising the steps of:
executing an on-line shopping platform by a system server and connecting a first electronic device and a plurality of second electronic devices to the on-line shopping platform;
using the first electronic device to transmit a buyer's request-to-buy message related to a specific object to the on-line shopping platform; and
using each of the second electronic devices to transmit a condition message replied by each purchaser acting on behalf of the buyer to the on-line shopping platform for the buyer to choose therefrom.

12. The push-pull shopping method of claim 11, further comprising the step of:
using the system server to transmit the request-to-buy message to each of the second electronic devices near a specified buying location for each of the purchasers acting on behalf of the buyer to reply to, if the request-to-buy message includes the specific buying location specified by the buyer.

13. The push-pull shopping method of claim 11, wherein the condition message comprises a price and a time for purchasing the specific object, and the price and the time for purchasing the specific object are determined by each of the purchasers acting on behalf of the buyer.

14. The push-pull shopping method of claim 12, wherein the condition message comprises a price and a time for purchasing the specific object, and the price and the time for purchasing the specific object are determined by each of the purchasers acting on behalf of the buyer.

15. The push-pull shopping method of claim 12, further comprising the step of: using the system server to transmit the request-to-buy message to each of the second electronic devices according to position information provided by each of the second electronic devices.

16. The push-pull shopping method of claim 15, further comprising the step of: transmitting the request-to-buy message by the system server to each of the second electronic devices within a predetermined range of distance from the specified buying location.

17. The push-pull shopping method of claim 11, wherein the request-to-buy message includes a desired product, a location for buying the desired product, and a description of the desired product.

18. The push-pull shopping method of claim 11, further comprising the step of:
receiving a payment made by the buyer through a pre-authorized online payment mechanism to authorize a specified purchaser acting on behalf of the buyer in advance to buy the specific object.

19. The push-pull shopping method of claim 18, wherein the online payment mechanism is an online transaction payment platform or a credit card.

20. The push-pull shopping method of claim 18, further comprising the step of: receiving a delivery order number of the specific object inputted by the specified purchaser acting on behalf of the buyer, notifying the buyer by a message, and making payment to the specified purchasers acting on behalf of the buyer through the online payment mechanism by the on-line shopping platform.
